(19) United States
(12) Patent Application Publication
(10) Pub. No.: US 2019/0056970 A1
(43) Pub. Date: Feb. 21, 2019

(54) Method for computer-aided coupling a processing module into a modular technical system and modular technical system

(71) Applicant: Siemens Aktiengesellschaft, Munchen (DE)

(72) Inventor: Rene Graf, Zirndorf (DE)

(73) Assignee: Siemens Aktiengesellschaft, Munchen (DE)

(21) Appl. No.: 15/999,194

(22) Filed: Aug. 16, 2018

(30) Foreign Application Priority Data
Aug. 16, 2017 (EP) 17186422.6

(51) Int. Cl. G06F 9/455; G06F 9/50; G06F 8/10; G06F 9/54

(52) U.S. Cl. CPC G06F 9/45558; G06F 9/5077; G06F 8/10; G06F 2009/45595; G06F 9/5055; G06F 9/5044; G06F 9/54; G06F 9/5016

(57) ABSTRACT

In a method for computer-aided coupling a processing module into a modular technical system, wherein the technical system has a host system designed to provide a virtual machine having real-time capability, and a processing module with a hardware unit having sensor or an actuator, and a connection unit having a communication component for controlling the hardware unit by way of control instructions and a data memory storing configuration data and a control program for providing the control instructions. Data messages are exchanged between the processing module and the host system via the connection unit. The following steps are carried out: The method includes reading the configuration data and the control program from the data memory; instantiating a virtual machine on the host computer; loading the configuration data and the control program into the virtual machine; and transmitting control instructions to the processing module for controlling the hardware unit.

### CROSS-REFERENCES TO RELATED APPLICATIONS

This application claims the priority of European Patent Application, Serial No. 17186422.6, filed Aug. 16, 2017, pursuant to 35 U.S.C. 119(a)-(d), the disclosure of which is incorporated herein by reference in its entirety as when fully set forth herein.

### BACKGROUND OF THE INVENTION

The present invention relates to a method for computer-aided coupling and computer-aided decoupling a processing module in a modular technical system. The invention also relates to a modular technical system and to a computer program product.

The following discussion of related art is provided to assist the reader in understanding the advantages of the invention, and is not to be construed as an admission that this related art is prior art to this invention.

Many computation processes are combined on servers in the course of concentrating and centralizing data processing, wherein the servers in turn are accommodated in server farms of data processing centers. This considerably simplifies the maintenance of the individual servers and concentrates the specific know-how on site.

A similar development exists in the field of programmable logic controllers (PLC). These devices are used to control or regulate a machine or installation (generally: a technical system) and are digitally programmed. In order to minimize the conventional wiring complexity, sensors and actuators are connected to a PLC via a field bus.

In the recent past, the bus systems in modern installations have been superseded by networks or supplemented with the latter. In comparison with bus systems, networks (for example Ethernet) can be used in a more flexible manner and are faster during data transmission. However, a high degree of reliability of these systems in connection with programmable logic controllers can be achieved only within the scope of real-time systems. A real-time system reacts in good time to all events and processes the data “in line” with the technical process. In the case of software which is intended to comply with real-time conditions, the maximum run time must be able to be determined and must not be subject to any factors which cannot be influenced or can be influenced only to a limited extent, in other words: it must be deterministic. The performance of a process within a particular interval of time is referred to as deterministic.

The technical system considered in the present invention is overall a real-time system, that is to say both all interacting hardware components and software components react in a deterministic manner, in particular.

The virtualization technology (VT) known from the prior art is used substantially to divide hardware into smaller parts, for example a multicore processor which is broken up into virtual processors with only one core or a few cores by means of virtualization technology. A main memory which is physically present only once can likewise be accordingly divided, with the result that each virtual processor is assigned a fixed portion of the main memory. This division may be static, or else may be carried out dynamically, that is to say a change in the allocation during the run time may be permitted. A similar situation applies to the peripherals present in a computer system, such as hard disks, network connections and the like.

The system or conglomerate of virtual processors, proportionate memory and assigned peripherals is referred to as a virtual machine (VM). A physical computer having corresponding resources can therefore operate or provide virtually any desired number of virtual machines. In this case, the physical computer itself is referred to as the host computer. During operation of the virtual machines, the host computer or host for short must itself become active, specifically when hardware in a virtual machine does not have a physical counterpart, but rather is only emulated. Emulation of virtual network cards with real-time capability on a processor apparatus is disclosed, for example, in WO 2013/064181 A1.

Flexibility is particularly important in modular technical systems, that is to say installations or machines. This means that individual modules of the installation or machine can be easily removed or arranged at another location so that the entire installation or machine can be adapted to a current product and its production process. The automation of such installations or machines must fundamentally take this flexibility into account and therefore cannot have a static structure, as was the case in the past. Their controllers should likewise be implemented in server farms or server clusters.

The combination of these two above-mentioned requirements poses great challenges for the development of the installations or machines. Programmable logic controllers have hitherto been manually produced, irrespective of whether they are virtually or actually provided, and have been manually connected to the module which is assigned to the programmable logic controller and has interfaces and sensors and/or actuators. This entails the disadvantage that the connection is susceptible to faults. On the other hand, a large amount of knowledge of the IT infrastructure is required when providing the programmable logic controller in server clusters or farms.

It would therefore be desirable and advantageous to obviate prior art shortcomings and to provide an improved method which can be used to integrate a processing module into a modular technical system in a simpler manner, and to provide an improved modular technical system which makes it possible to couple or decouple a processing module in the system in a simpler manner.

### SUMMARY OF THE INVENTION

According to one aspect of the present invention, a method for computer-aided coupling of a processing module into a modular technical system, with the technical system including a host system providing a virtual machine having real-time capability, and with the processing module including a hardware unit having a sensor, an actuator, a connection unit with a communication component for controlling the hardware unit by way of control instructions, and a data memory storing configuration data and a control program providing the control instructions, with the connection unit coupling the processing module to the host system for interchanging data messages, includes the steps of:
a1) reading the configuration data and the control program from the data memory;
b1) instantiating a virtual machine on the host computer;
c1) loading the configuration data and the control program into the virtual machine on the host system; and
d1) executing the virtual machine for providing the control instructions and transmitting the control instructions to the processing module for controlling the hardware unit.

A method according to the present invention automates the production and management of virtual controllers for modular technical systems with the aid of virtual machines. In this case, the basic concept provides for the individual processing modules themselves to no longer have a programmable logic controller (PLC), but rather to be operated using an external controller. For this purpose, the processing modules or only some processing modules provide the necessary information contained in the configuration data and the control program. The dynamic production of the controllers assigned to the processing modules has the advantage that the integration into the modular technical system using network technology can be implemented automatically and the processing module does not need to have any knowledge whatsoever of the implementation using network technology. This in turn facilitates the replacement of individual processing modules and a flexible arrangement inside the technical system.

In heterogeneous modular technical systems in particular, the start-up effort is reduced considerably when all processing modules are based on the same control architecture irrespective of their manufacturer.

Improved fail-safety is also ensured in large modular technical systems. As a result, it is also possible to dynamically instantiate fail-safe controllers (F-PLCs) which can establish communication connections both to the hardware unit assigned to them and to further (fail-safe or normal) controllers.

A method according to the present invention also makes it possible to deliver processing units without their own controller since their virtual controllers can be centrally implemented and processed, wherein the processing units are “pre-configurable” before delivery.

According to another advantageous feature of the present invention, the steps of reading (step a1)), instantiating (step b1)) and loading (step c1)) can be carried out by a management entity executed on the host system. The management entity is software which is executed on the host system and undertakes the central steps of coupling a respective processing module to the modular technical system in a computer-aided manner. In this case, the management entity can determine whether a new processing module has been connected to the technical system and would like to be coupled to the technical system. The management entity is additionally able to determine whether the processing module includes a controller (PLC) or only a hardware unit and the controller must therefore be implemented with the aid of the virtual machine on the host computer. The management entity thereby makes it possible to operate the technical system in a mixed mode with processing modules with their own controller and without their own controller (these are those processing modules which are controlled via a virtual controller).

According to another advantageous feature of the present invention, the step of reading the configuration data and the control program (step a1)) can include copying the configuration data and the control program to a memory of the host system, wherein the copying is carried out before the instantiation, in particular. This also makes it possible to access the configuration data and the control program at a later time when it is no longer possible to access the data memory.

According to another advantageous feature of the present invention, the management entity can allocate a network address to the processing module after a connection has been established between the at least one processing module and the host system. The establishment of a connection between the at least one processing module and the host system can be determined, after the at least one processing module has been physically connected to a corresponding connection of the technical system, by supplying the processing unit with voltage after connection, with the result that the hardware unit contained in the processing module starts. As a result, the processing module can actively register in the network and a network address is consequently allocated to the processing module.

According to another advantageous feature of the present invention, the management entity can interchange the data messages using a communication protocol running on layer 4 of the OSI (Open Systems Interconnection) reference model after the network address has been allocated. This enables communication between the management entity and the at least one processing module in order to be able to instantiate a virtual machine on the host computer. OPC-UA (Open Platform Communications Unified Architecture), for example, can be used as the communication protocol.

According to another advantageous feature of the present invention, the management entity can check whether the at least one processing module has its own control unit for executing the control program, wherein the steps of instantiating (step b1)), loading the configuration data and the control program (step c1)) and executing the virtual machine (step d1)) are carried out only when the processing module does not have its own control unit.

When determining during communication that the processing module to be connected to the technical system has its own (real) controller (PLC), the steps just mentioned are dispensed with.

According to another advantageous feature of the present invention, the management entity can determine the performance requirement of the virtual machine for executing the control program by evaluating the configuration data and to provide said performance requirement. For example, it is possible to determine in this step what performance of the virtual machine is required or expedient for the hardware unit. When various performance levels are available, the performance level best suited to the processing module can be instantiated in the virtual machine. Requirements, such as the firmware version, of the virtual controller may likewise be specified in the configuration.

According to another advantageous feature of the present invention, provision can be made for a first network connection at least to the management entity and a second network connection to the assigned processing module for the virtual machine. The virtual machine has two network connections, namely a connection to the management entity and to other (virtual or real) controllers of the technical system and another interface to the hardware units of the processing modules to be controlled. The first interface to the management entity is configured, for example using DHCP or another protocol, such that the virtual machine can be addressed thereby. A network switch present in the technical system is configured in such a manner that a hardware unit interface of the virtual machine is connected to the line to the processing module. In this case, bandwidth or latency requirements can be taken into account depending on the network. In other words, all logical connections are established via all network components of the technical system from the virtual machine to the processing module to be controlled.

According to another advantageous feature of the present invention, the technical system can include a basic system having at least one connection interface with at least one network connection and one supply connection for coupling to the at least one processing module as well as a coupling element (switch) for coupling to the host system, wherein the management entity establishes a logical connection via all network nodes on a path between the virtual machine and the connection unit of the processing module.

Instead of step a1), according to another advantageous feature of the present invention, an image of the control program can be loaded from the data memory of the host system as step a1) and loaded into the virtual machine without change in step c1). The variation in this configuration is that a data memory does not contain the configuration data and the control program of the controller, but rather a complete image of the virtual machine (with real-time capability) to be started. In this case, the image read from the data memory is started, in which case it is only necessary to ensure, when establishing the network configuration, that the virtual machine can communicate both with other logical components, in particular of the basic system, and with the hardware unit of the processing module to be controlled. On the one hand, this allows the virtual machine to be exactly matched to the processing module. On the other hand, further software components, apart from the pure controller for the processing module, can be included in a complete image and are started in a parallel manner, for example for a visualization or for accessing a database.

More complex machine control can be virtualized with the aid of an image, in particular when, instead of one image, there are a plurality of images which (can be) are started in a parallel manner in separate virtual machines in each case.

According to another configuration, instead of the virtual machine, a real controller can be instantiated in step b1), wherein steps c1) and d1) are then carried out for the real controller.

According to another aspect of the present invention, in a method for computer-aided decoupling a processing module in a modular technical system, with the technical system including a host system which is designed to provide at least one virtual machine having real-time capability, and with the processing module including a hardware unit with a sensor and/or actuator as well as a connection unit with a communication component for controlling the hardware unit by means of control instructions and a data memory which stores configuration data and a control program for providing the control instructions, with the connection unit coupling the processing module to the host system for interchanging data messages, a management entity running on the host system is designed to carry out the steps of:
a2) causing a safe state of the at least one processing module,
b2) terminating the virtual machine assigned to the at least one processing module and removing it from the host system,
c2) removing network connections which have been set,
d2) decoupling the at least one processing module.

In a similar manner to the coupling process, a processing module can also be decoupled in an automated manner. The decoupling is carried out in response to a request to the management entity, which request is transmitted to the management entity either by the processing module to be decoupled or by the communication component itself.

According to another advantageous feature of the present invention, in step b2), a real controller can be marked as available when, instead of the virtual machine, a processing module controlled by a real controller is intended to be decoupled from the technical system. A full reset can then be carried out in order to be in a defined state for the next use.

According to still another aspect of the present invention, a computer program product can be directly loaded into the internal memory of a digital computer and includes software code sections which are used to carry out the steps of a method according to the invention, when the product runs on a computer. The computer program product may be embodied in the form of a CD-ROM, a DVD, a USB memory stick and the like. It may also be in the form of a signal which can be loaded via a (contactless or contact-based) network.

According to yet another aspect of the present invention, a modular technical system includes a host system which is designed to provide a virtual machine having real-time capability, and a processing module including a hardware unit having a sensor and/or an actuator, a connection unit with a communication component for controlling the hardware unit by way of control instructions, and a data memory storing configuration data and a control program providing the control instructions, with the connection unit coupling the processing module to the host system for interchanging data messages. A management entity running on the host system is designed to carry out the following steps:
a1) reading the configuration data and the control program from the data memory;
b1) instantiating a virtual machine on the host computer;
c1) loading the configuration data and the control program into the virtual machine on the host computer.
   The host system is designed to carry out the following step:
d1) executing the virtual machine for the purpose of providing at least the control instructions and transmitting the control instructions to the at least one processing module for controlling the hardware unit.

A modular technical system according to the invention has the same advantages as described above in connection with the method according to the invention.

According to another advantageous feature of the present invention, the system can include a basic system having a connection interface with a network connection and a supply connection for coupling to the at least one processing module as well as a coupling element (switch) for coupling to the host system, wherein the management entity is designed to establish a logical connection via a network node on a path between the virtual machine and the connection unit of the processing module.

According to another advantageous feature of the present invention, the management entity running on the host system can be designed to carry out the following steps:
a2) causing a safe state of the at least one processing module;
b2) terminating the virtual machine assigned to the at least one processing module and removing it from the host system;
c2) removing network connections which have been set.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic illustration of a processing module in a modular technical system according to the present invention;

FIG. 2 shows a schematic illustration of a modular technical system according to the invention including a host system, a basic system and a plurality of processing modules according to the present invention in accordance with a first configuration variant;

FIG. 3 shows a schematic illustration of a modular technical system according to the present invention in which the host system is in the form of a server cluster; and

FIG. 4 shows a schematic illustration of a modular technical system according to the present invention in which the controllers are implemented by means of real controllers of the host system.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

The following description describes methods for computer-aided coupling and computer-aided decoupling a processing module in a modular technical system. As a result, processing modules can be flexibly and easily arranged and rearranged in the technical system so that the technical system can adapt to a required production process.

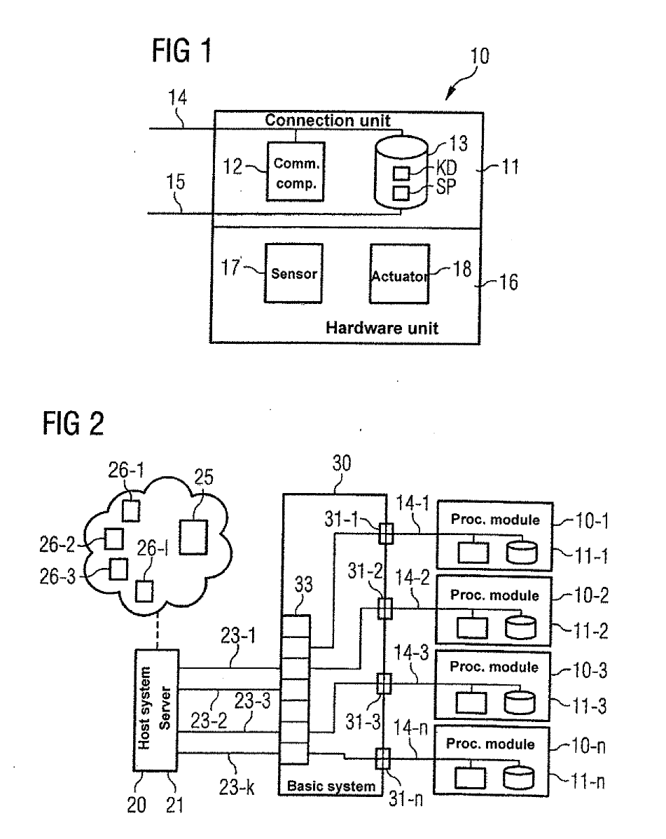

Turning now to the drawing, and in particular to FIG. 1, there is shown a schematic illustration of the fundamental structure of a processing module 10 used in this case. The processing module 10 includes a connection unit 11 and a hardware unit 16. The hardware unit 16 includes, by way of example, at least one sensor 17 and at least one actuator 18. The hardware unit 16 can also include any desired electrical and mechanical components. The hardware unit 16 could alternatively also include only at least one sensor 17 or at least one actuator 18.

The connection unit 11 includes a communication component 12 and a data memory 13. The communication component 12 is used to control the hardware unit 16 by means of control instructions. The data memory 13 stores configuration data relating to the processing module 10 and a control program SP for providing the control instructions for the processing module 10. The configuration data KID and the control program SP are stored in the data memory 13 by the manufacturer of the processing module 10.

The communication component 12 and the data memory 13 are connected to a field bus 14. Any Ethernet-based field bus, for example Profinet, can be used as the field bus 14. The data memory 13 is optionally connected to a further network line 15, for example Ethernet.

The communication component 12 and the data memory 13 are connected to the technical system 1 via the field bus 14 (see FIGS. 2 to 4). Contrary to the illustration in the drawing, the communication component 12 and the data memory 13 could also be connected to the technical system 1 via field buses or Ethernet-based buses which are separate from one another. During operation of the technical system, time-critical data for controlling the processing module 10 are transmitted via the field bus 14.

The communication component 12 is in the form of a converter assembly, for example, which converts received electrical signals into communication signals for controlling the hardware unit 16. The communication component 12 is therefore preferably arranged in the spatial vicinity of the hardware unit 16.

FIG. 2 shows a schematic illustration of a basic configuration of a technical system 1 according to the invention. The modular technical system 1 includes a server 21 as the host system 20, a basic system 30 and n processing modules 10-i (i=1 . . . n). Each of the processing modules 10-i is designed as described in connection with FIG. 1.

The basic system 30 provides the infrastructure for the technical system 1, for example voltages, currents, network connections, compressed air and the like. The basic system 30 includes a plurality of defined (local) positions at which the processing modules 10-i can be docked. These positions are each provided with connection interfaces 31-i (i=1 . . . n), wherein each of the connection interfaces 31-i includes at least one network connection and one supply connection. It is also possible to provide further connections which are designed according to the requirements of the relevant processing module. The exact configuration of the connection interface 31-i is of minor importance in the present case since they do not play a role in networking the controller to the processing modules 10-i.

Virtual controllers 26-l (I=1 . . . x, where x≤n) can be instantiated on the host system 20. The host system also includes physical network connections, with the result that the server 21 has a corresponding number of connecting lines 23-k (k=1− . . . o, where o≥n), on which a respective processing module 10-i can be connected to the host system 20 via a coupling element 33, for example a switch. It is expedient when the coupling element 33 is part of the basic system 30, but this is not compulsory. The configurable coupling element 33 ensures the necessary flexibility, in which case the coupling element 33 can be real or optionally virtual. A design as a virtual coupling element can be gathered from WO 2013/064181 A1 from the applicant, for example.

A management entity 25 which is used to instantiate and manages the virtual controllers 26-l runs in the host system 20. The management entity 25 is set up to determine whether a new processing module 10-i has been connected to one of the connection interfaces 31-i of the basic system 30 and has been switched on. The management entity 25 also determines whether the processing module 10-i includes a physical controller or only the connection unit 11 and the hardware unit 16 mentioned at the outset. In the latter case, as will be described in more detail below, a virtual machine is generated for the purpose of controlling the processing module 10-i. Otherwise, a real controller is used to control the processing module (see FIG. 4), with the result that mixed operation of modules with and without a controller is possible overall in the technical system.

The technical system 1 can have a very heterogeneous structure, with the result that a comprehensive communication protocol, for example OPC-UA, is preferably used in order to be able to interchange data in a coordinated manner between the processing module 10-i and the basic system 30 and the host system 20. Reference is made to OPC-UA, for example, as the protocol below. However, other protocols can also be used to implement the methods described below. When a processing module 10-i is connected to the basic system 30, the processing module 10-i is allocated a network address which is used by the management entity 25 to address the processing module 10-i. During this communication, it is determined whether an OPC-UA server of the processing module 10-i is registered, for example. When this is not the case, the processing module 10-i does not contain a controller, with the result that a virtual controller is produced using the methods described below.

Without restricting the generality, it is assumed in the following description of the method that the data memory 13 of a newly connected processing module 10-i is not registered to the selected communication protocol (for example OPC-UA), but rather provides the configuration data KD and the control program SP of the controller to be produced in a format previously stipulated in the technical system 1.

The sequence of the computer-aided coupling is as follows:
1. Physical docking: the processing module 10-i is mechanically connected to the assigned connection interface 31-i, with the result that the processing module 10-i can carry out the work steps relevant to production. In particular, connection to a network connection of the connection interface 31-i is carried out with the aid of a line for the field bus 14-i. At the same time, the processing module 10-i to be coupled to the technical system 1 is supplied with voltage, with the result that all components of the processing module 10-i to be coupled start up.
2. Network integration: a computing unit of the data memory 13 of the processing module 10-i to be coupled is actively registered in order to initiate the allocation of a network address (IP address). This is typically carried out by means of the DHCP protocol, but can also be implemented in another manner provided that a corresponding definition has been defined between the host system 20 and the processing module 10-i to be connected. A DHCP server which is responsible for all network connections of the connection interfaces 31-i which are currently not occupied by a processing module 10-i runs in the server 21 of the host system 20.
3. Requirement identification: the management entity 25 in the server 21 determines that a new processing module 10-i has been connected to the basic system 30. The management entity asks the processing module 10-i, for example by OPC-UA, whether it has its own controller (PLC). The dynamic instantiation is started from the absence of a response or from a firm response indicating that this is not the case. The requirement identification and the communication taking place during the further, subsequent steps take place on layer 4 of the OSI reference model.
4. Data backup: in this step, the configuration data KD and the control program SP from the data memory 13 are copied to a memory (not illustrated) accessible to the server 21. This is carried out since, after the virtual machines have been configured via the field bus 14-i, the data memory 13 can no longer be reached under certain circumstances, in particular when no optional network line 15 to the data memory 13 has been provided. The virtual machine can then be configured with the aid of the configuration data KD and the control program SP without directly accessing the data memory 13 of the processing module 10-i to be coupled and can be provided with the virtual controller (virtual PLC).
5. Virtual control: the management entity which runs on the server 21 starts a new entity of a virtual machine 26-l in the host system 20, in which case this can be carried out on any desired computing node or computing core of the host system 20. The virtual machine 26-l initially does not have a configuration or a program. The configuration data KD can be used to determine the performance requirement required by the processing module 10-i to be coupled. When various performance levels are available for virtual machines, the appropriate virtual machine 26-l can be instantiated. Further requirements, for example the firmware version, of the virtual machine 26-l can likewise be specified in the configuration of the configuration data KD.
6. The virtual machine (which, as it were, constitutes a PLC) has two network connections. A first network connection to the management entity 25 and to the other virtual machines 26-l of the technical system 1 exists. Another network connection to the processing module 10-i to be coupled exists. The management entity 25 is configured, for example using DHCP or another protocol, in such a manner that the virtual machine 26-l can be addressed via the network connection.
7. Network configuration: the coupling element 33 of the basic system 30 is configured next, with the result that the network interface of the virtual machine 26-l is connected to the assigned line 23-k. In this case, bandwidth or latency requirements can also be taken into account depending on the configuration of the network topology. In this step, the connection to the data memory 13 of the processing module 10-i to be coupled may be lost. However, this is not important since its data KD and SP have previously been copied to a memory accessible to the server 21.
8. During the network configuration, all logical connections are therefore established via all network components in the chain between the virtual machine and the processing module 10-i to be coupled.

Loading the virtual controller: the management entity 25 now loads both the configuration data KD and the control program SP into the virtual machine 26-l and starts the latter, with the result that the communication component 12 becomes active and the processing module 10-i can start production. In addition, the virtual machine 26-l can communicate with the other processing modules 10-i or with the basic system 30 via the installation network interface, with the result that production orders or the like can be transmitted to the processing module.

This fundamental sequence which includes steps 1 to 7 can be varied with the aid of the following options. As an alternative to the configuration data KD and the control program SP in the data memory 13 of the processing module 10-i to be coupled, a complete image of the virtual machine (with real-time capability) to be started can be stored in the data memory 13. This can be checked, for example, in step 3 of the method described above. The image copied into a memory of the server 21 is therefore started in step 5. Step 7 can be omitted, in which case the network configuration must nevertheless ensure that the virtual controller can communicate both with the basic system 30 and with the communication component 12 of the processing module 10-i to be connected.

On the one hand, this modification allows the virtual machine, which enables virtual control, to be exactly matched to the processing module 10-i. This makes it possible to circumvent a problem in which the server 21 accepts a controller which is available from an available pool for the virtual machine. On the other hand, further software components in addition to the pure control program can be provided in a complete image and can be started in a parallel manner. This may relate to a visualization or a database, for example.

Overall, complex machine controllers can be virtualized using this modification. In particular, it is also possible to store not only one image but rather a plurality of images in the data memory 13 of the processing module 10-i to be coupled.

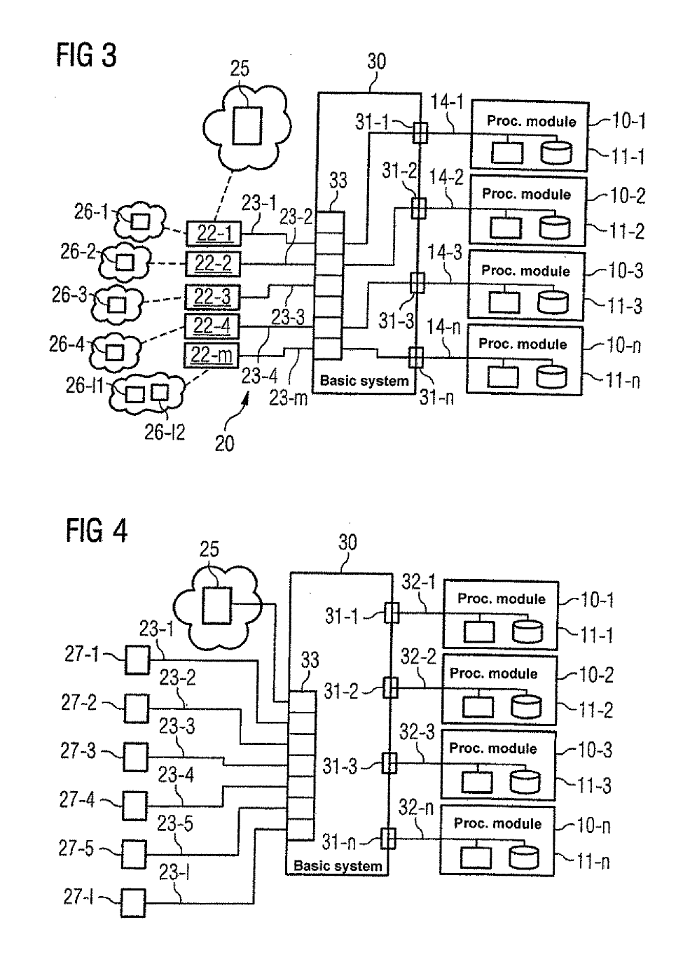

FIGS. 3 and 4 show minor modifications to the technical system shown in FIG. 2. In the embodiment variant according to FIG. 3, the host system 20 includes a server cluster 22 having a number j of servers 22-j (j=1 . . . m). The basic method of operation is identical, in which case individual virtual controllers 26-l are assigned to respective servers 22-j in the server cluster 22. A server cluster can in total include just as many cores as the server 21 illustrated in FIG. 2.

On account of the higher number of servers, the number of network components can also substantially increase, with the result that the automatic network configuration requires a larger amount of information relating to all components. For the sake of simplicity, the explicit illustration of the additive network components was omitted in FIG. 3 since their precise configuration depends on the specific expansion of the server cluster 22. One advantage of using a server cluster 22 is increased fail-safety on account of the presence of redundancies.

The scenario described in connection with FIG. 2 can also be implemented using real controllers 27-l (l=1 . . . x) which replace the virtual controllers from the embodiment variants in FIGS. 2 and 3. Mixed forms are also possible in this case. Although the technical system shown in FIG. 4 also operates dynamically, the coupling element 33 is real. In addition to the controllers in the real controllers 27-l, the management entity 25 runs in the network, for example on a separate computer. The sequence corresponds substantially to the previously described sequence, with the exception that a virtual controller is not started, but rather a real controller which has hitherto not yet processed a control program is selected. This is then loaded with the configuration data KD and the control program SP stored in the processing module and is started.

Another alternative relates to a configuration at the run time. In order to execute a control program and communicate with the communication component of the processing module 10-i to be coupled, a separate virtual controller need not necessarily be instantiated for each individual processing module. Controllers often have a feature called CiR (“Configuration in Run”) which allows further assemblies to be additively configured during ongoing operation of a controller and allows additional program parts, which operate with the data relating to these new assemblies, to be loaded. These expansions can also be removed from the control program during ongoing operation. For use in a CiR application, the data from the control program can be specially processed. The number of controllers can then be reduced. In this configuration, it must be ensured in the network configuration in step 6 that the processing module to be coupled is connected to the communication network which is already present for the virtual machines used.

The method for decoupling a processing module 10-i is described below. For decoupling, an decoupling request is transmitted to the management entity 25. The decoupling request can be transmitted either by the processing module to be decoupled or by the basic system 30. The further sequence is as follows:
1. Inform processing module: the processing module or its virtual controller 26-l is informed, using a protocol previously stipulated for the basic installation, for example OPC-UA, that the processing module 10-i is intended to be disconnected from the basic system 30.
2. Shut down processing module: the virtual controller changes the processing module 10-i to a safe state and reports this to the management entity 25. The controller of a virtual machine itself optionally switches to a stop state. Alternatively, this can be prompted by the management entity. When the CiR feature is used, the controller of a virtual machine can also control further processing modules and therefore must not change to the stop state. Instead, the management entity 25 unloads parts of the configuration data KD and of the control program SP which are no longer active from the controller of the virtual machine 26-l, while the other parts continue to run.
3. Deactivate controller: in the case of a virtual controller, the latter is shut down and the virtual machines 26-l are then removed from the server 21. When, as described below, real controllers are used, they are marked as available in the management entity 25 and a full reset is then carried out in order to be in a defined state for the next use. It is likewise possible to only carry out a full reset, rather than to shut down the virtual controllers, so that they can be subsequently reused for another module.
4. Reset network: set network connections to the processing module 10-i to be decoupled are removed and the port is directly connected to the management entity 25, with the result that it can be reused for a new processing module.
5. Switch off module: the voltage supply for the processing module 10-i to be decoupled is disconnected, as a result of which the processing module can then be removed from the connection interface 31-i of the basic system 30.

The method makes it possible to automatically instantiate virtual controllers and connect the networks, which was previously carried out manually. This enables the CaaS (Control as a Service) scenario in which automation computation power can be dynamically provided. In the CaaS scenario, a machine or installation manufacturer can deliver its processing modules without their own controller or can operate a similar server or server cluster for virtual controllers on site in order to thus activate its processing modules before delivery. The equivalence of the controllers with the machine manufacturer and with the operator of the technical system is therefore increased or completely identical, with the result that an acceptance test with the operator of the technical system leads to identical results even though the controller is a different controller.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for computer-aided coupling of a processing module into a modular technical system, with the technical system including a host system providing a virtual machine having real-time capability, and with the processing module including a hardware unit having a sensor, an actuator, a connection unit with a communication component for controlling the hardware unit by way of control instructions, and a data memory storing configuration data and a control program providing the control instructions, with the connection unit coupling the processing module to the host system for interchanging data messages, said method comprising the steps of:
a1) reading the configuration data and the control program from the data memory;
b1) instantiating a virtual machine on the host computer;
c1) loading the configuration data and the control program into the virtual machine on the host system; and
d1) executing the virtual machine for providing the control instructions and transmitting the control instructions to the processing module for controlling the hardware unit.

2. The method of claim 1, wherein the steps a1), b1) and c1) are carried out by a management entity executed on the host system.

3. The method of claim 1, wherein the step a1) comprises copying the configuration data and the control program to a memory of the host system, wherein copying is performed before step b1).

4. The method of claim 2, wherein the management entity allocates a network address to the processing module after a connection has been established between the processing module and the host system.

5. The method of claim 4, wherein after the network address has been allocated, the management entity interchanges the data messages using a communication protocol running on layer 4 of an OSI (Open Systems Interconnection) reference model.

6. The method of claim 2, wherein the management entity checks whether the processing module has its own control unit for executing the control program, and wherein the steps b1), c1) and d1) are carried out only when the processing module does not have its own control unit.

7. The method of claim 2, wherein the management entity evaluates the configuration data and determines therefrom and provides a performance requirement of the virtual machine for executing the control program.

8. The method of claim 2, further comprising establishing with the virtual machine a first network connection to the management entity and a second network connection to the assigned processing module.

9. The method of claim 2, wherein the technical system further comprises a basic system having a connection interface with a network connection and a supply connection for connecting to the processing module as well as a coupling element for connecting to the host system, wherein the management entity establishes a logical connection via all network nodes on a path between the virtual machine and the connection unit of the processing module.

10. The method of claim 1, wherein step a1) is replaced by a step a2) which comprises loading an image of the control program from the data memory of the host system, and further loading the image into the virtual machine at step c1) unaltered.

11. The method of claim 1, wherein steps b1), steps c1) and d1) are carried out with a real controller instead of the virtual machine.

12. A method for computer-aided decoupling of a processing module in a modular technical system, with the technical system including a host system providing a virtual machine having real-time capability, and with the processing module including a hardware unit having a sensor, an actuator, a connection unit with a communication component for controlling the hardware unit by way of control instructions, and a data memory storing configuration data and a control program providing the control instructions, with the connection unit coupling the processing module to the host system for interchanging data messages, said method comprising the steps of:
a2) causing a safe state of the processing module;
b2) terminating the virtual machine assigned to the processing module and removing the virtual machine from the host system;
c2) removing established network connections; and
d2) decoupling the processing module.

13. The method of claim 12, wherein a real controller is used instead of the virtual machine, wherein at step b2) the real controller is marked as available when a processing module controlled by the real controller is to be decoupled from the technical system.

14. A modular technical system, comprising:
a host system providing a virtual machine having real-time capability;
a processing module comprising a hardware unit having a sensor, an actuator, a connection unit with a communication component for controlling the hardware unit by way of control instructions, and a data memory storing configuration data and a control program providing the control instructions, with the connection unit coupling the processing module to the host system for interchanging data messages and
a management entity executed on the host system and configured to
a1) read the configuration data and the control program from the data memory;
b1) instantiate a virtual machine on the host system;
c1) load the configuration data and the control program into the virtual machine on the host computer; and
d1) the host system configured to execute the virtual machine for providing the control instructions and transmitting the control instructions to the processing module for controlling the hardware unit.

15. The system of claim 14, further comprising:
a basic system having a connection interface with a network connection and a supply connection for connecting to the processing module, and a coupling element for connecting to the host system,
wherein the management entity is configured to establish a logical connection via all network nodes on a path between the virtual machine and the connection unit of the processing module.

16. The system of claim 14, wherein the management entity executed on the host system is designed to carry out the following steps:
a2) causing a safe state of the processing module;
b2) terminating the virtual machine assigned to the processing module and removing the virtual machine from the host system; and
c2) removing established network connections.

17. A computer program product stored on a non-transitory medium and comprising software code sections, which when loaded into an internal memory of a digital computer and executed on the digital computer, cause the digital computer to couple a processing module into a modular technical system, with the technical system including a host system providing a virtual machine having real-time capability, and with the processing module including a hardware unit having a sensor, an actuator, a connection unit with a communication component for controlling the hardware unit by way of control instructions, and a data memory storing configuration data and a control program providing the control instructions, with the connection unit coupling the processing module to the host system for interchanging data messages, and with a management entity executed on the host system by:
a1) reading the configuration data and the control program from the data memory;
b1) instantiating a virtual machine on the host system;
c1) loading the configuration data and the control program into the virtual machine on the host computer; and
d1) executing the virtual machine for providing the control instructions and transmitting the control instructions to the processing module for controlling the hardware unit.
